(19) United States
(12) Patent Application Publication
(10) Pub. No.: US 2026/0022762 A1
(43) Pub. Date: Jan. 22, 2026

(54) TRANSMISSION MECHANISM WITH INTERNAL LUBRICATION AND ASSOCIATED ELECTRIC PROPULSION UNIT

(71) Applicant: VALEO EMBRAYAGES, Amiens Cedex 2 (FR)

(72) Inventors: Philippe KRAEMER, Cergy Pontoise (FR); Antonin CHERON, Cergy Pontoise (FR)

(73) Assignee: VALEO EMBRAYAGES, Amiens Cedex 2 (FR)

(21) Appl. No.: 19/269,673

(22) Filed: Jul. 15, 2025

(30) Foreign Application Priority Data
Jul. 16, 2024 (FR) FR2407755

(51) Int. Cl. F16H 57/04; F16H 57/02; F16H 57/021; F16H 57/027; F16H 57/029

(52) U.S. Cl. CPC F16H 57/0423; F16H 57/021; F16H 57/027; F16H 57/029; F16H 57/0424; F16H 57/045; F16H 57/0457; F16H 57/0471; F16H 57/0472; F16H 2057/02034; F16H 2057/02052

(57) ABSTRACT

A transmission mechanism with internal lubrication, including a speed reduction device having at least a first transmission shaft extending along a first axis of rotation and coaxially bearing a first gear wheel, and a hollow casing including a base and a peripheral wall integrally formed with the base, the peripheral wall partially surrounding the speed reduction device. A lubricant receiving and distributing collector is positioned in the casing between the peripheral wall and the first axis of rotation. The lubricant receiving and distributing collector includes at least a bottom, an outer perimeter and an additional collecting device connected to the outer perimeter, the additional collecting device bearing on the peripheral wall and/or the base of the casing.

### TECHNICAL FIELD OF THE INVENTION

The invention relates to the internal lubrication, for example by splash lubrication, of the components of a transmission mechanism, and in particular of a transmission mechanism comprising a speed reduction device.

### PRIOR ART

To lubricate the components of a transmission mechanism, and in particular the bearings for guiding rotation and the gears of such a mechanism, it is known practice to place the movable components of the mechanism inside a casing containing lubricating oil. However, the movable components, for example the transmission shafts supporting the pinion and the gear wheel of a gear, are not fully submerged in the oil. It is thus the motion of the transmission mechanism which, by splash lubrication, stirs up the oil and splashes it throughout the interior volume of the casing, to ensure the desired lubrication of the entire mechanism, including the parts that are not submerged.

This type of transmission mechanism generally comprises a so-called “passive” lubrication device, that is, without a pump, in which a ramp is formed within the casing to promote the rise of lubricant from the bottom of the casing towards the top and thus disperse the lubricant in various regions of the speed reduction device. One or more fluid collectors are also placed in the casing and collect the splashed oil. The fluid collector then redistributes the fluid to different locations of the casing by means of supply pipes that channel the flow of fluid towards the guide bearings and the gears.

DE102010030035 A1 discloses such a transmission mechanism. This document includes two fluid collectors that recover the splashed oil within the transmission mechanism. However, the positioning and the form of the fluid collectors do not allow them to recover a large quantity of splashed fluid within the casing. The quantity of fluid recovered also depends on the speed of rotation of the gears that splash the oil. There is a need to improve the efficiency of such a transmission mechanism.

Guide bearings, for example ball bearings, must be lubricated at all times and generally have a flow of lubricating fluid passing through them. When they are insufficiently lubricated, there is a risk of the guide bearings overheating. The solution proposed in DE102010030035 A1 does not make it possible to ensure a sufficient flow of fluid within the guide bearing.

### SUMMARY OF THE INVENTION

The invention aims to overcome the drawbacks of the prior art and to propose a transmission mechanism that combines good lubrication of the guide bearings and low energy consumption at high speed.

To this end, according to a first aspect of the invention, a transmission mechanism with internal lubrication is proposed, comprising:
a speed reduction device comprising at least a first transmission shaft extending along a first axis of rotation X1 and coaxially bearing a first gear wheel,
a hollow casing comprising a base and a peripheral wall integrally formed with the base, the peripheral wall partially surrounding the speed reduction device,
a lubricant receiving and distributing collector positioned in the casing between the peripheral wall and the first axis of rotation X1,
   wherein the lubricant receiving and distributing collector comprises at least a bottom, an outer perimeter and an additional collecting device connected to the outer perimeter, the additional collecting device bearing on the peripheral wall and/or the base of the casing.

This transmission mechanism with its lubricant receiving and distributing collector provided with its additional collecting device has the advantage of recovering and distributing a large quantity of lubricant present within the speed reduction device, while maintaining the principle of passive lubrication.

The additional collecting device contributes to the recovery of lubricant by being positioned on the upper part of the collector. The lubricant is splashed by the first gear wheel towards the peripheral wall of the casing. The lubricant is then stopped by the additional collecting device before finally falling by gravity into the collector. The collector occupies a central position within the speed reducer, which enables it to receive all of the splashed lubricant coming from the first gear wheel but also from other gear wheels also present within the speed reduction device.

Preferably, the lubricant receiving and distributing collector is positioned axially, along the first axis of rotation X1, between the base of the casing and the first gear wheel, the first gear wheel rotating about the first axis of rotation X1 in a preferred direction, the additional collecting device facing the first gear wheel so that it receives the lubricant splashed by the teeth. Due to the orientation of the helical teeth, the lubricant is splashed towards the lubricant receiving and distributing collector.

Advantageously, the outer periphery of the first gear wheel may extend radially beyond the outer perimeter of the lubricant receiving and distributing collector. This facilitates the recovery of the lubricant.

According to one aspect of the invention, the transmission mechanism comprises a first guide bearing supporting the first transmission shaft relative to the casing, the first guide bearing being inserted into a first cylindrical recess formed in the casing, the lubricant receiving and distributing collector comprising a lubricant outlet pipe emerging towards the cylindrical recess.

Preferably, the additional collecting device is attached to the outer perimeter or integrally formed with the outer perimeter, the additional collecting device comprising a collecting wall that forms the join between the lubricant receiving and distributing collector and the casing.

For example, the end of the collecting wall in contact with the casing comprises a geometric shape that follows the interior shape of the casing, for example a curved shape.

According to one variant of the invention, the additional collecting device is an attached part comprising the collecting wall and a reinforcing wall positioned on one of the edges of the collecting wall, the reinforcing wall comprising a bearing surface bearing on the outer perimeter of the lubricant receiving and distributing collector.

The additional collecting device may be made from stamped metal or injection-moulded plastic.

Advantageously, the reinforcing wall may comprise snap-fitting tabs that extend towards the lubricant receiving and distributing collector, the additional collecting device being snap-fitted onto the outer perimeter.

According to another variant of the invention, the additional collecting device is integrally formed with the outer perimeter, the lubricant receiving and distributing collector comprising a flexible region forming the connection between the outer perimeter and the collecting wall, the flexible region being produced by localized narrowing of material or localized removal of material. The flexible region makes it possible to absorb the dimensional tolerances and ensure contact with the peripheral wall or base of the casing in all circumstances.

Preferably, the collecting wall is inclined relative to the outer perimeter. The lubricant is thus oriented towards the bottom of the lubricant receiving and distributing collector.

For example, the collecting wall applies a prestressing force to the peripheral wall and/or the base of the casing.

According to another variant of the invention, the additional collecting device is a seal attached to the outer perimeter.

For example, the seal may comprise a sealing lip that forms the join between the lubricant receiving and distributing collector and the casing. Advantageously, the sealing lip acts as the collecting wall. The sealing lip may deform elastically. The seal makes it possible to absorb the dimensional tolerances and ensure contact with the peripheral wall or base of the casing in all circumstances.

For example, the seal may be overmoulded on the outer perimeter of the lubricant receiving and distributing collector.

For example, the seal may be inserted into a groove formed on the outer perimeter of the lubricant receiving and distributing collector.

According to one aspect of the invention, the casing comprises, on the inner face of the peripheral wall, at least one drip situated vertically in line with the lubricant receiving and distributing collector, the drip taking the form of a protuberance of material and the additional collecting device bearing on the drip. For example, the profile of the drip may be linear and oriented in the direction of demoulding of the casing when the latter is obtained by casting. According to another example, the drip may be cone-shaped. According to another example, the drip may be machined directly in the casing. The drip allows more lubricant to be recovered within the collector. The lubricant that trickles along the peripheral wall preferably returns to the collector by following the shape of the drip rather than returning directly to the bottom of the speed reducer.

According to one aspect of the invention, the transmission mechanism comprises a breather supported by the casing, the inner end of the breather emerging into a cavity formed in the casing, the collecting wall of the additional collecting device at least partially covering the entrance to the cavity. For example, the entrance to the cavity emerges into the base of the main casing. The breather is in particular configured to prevent the pressure in the space enclosed by the casing from becoming too high relative to the pressure outside the space. The collecting wall prevents lubricant from splashing directly inside the cavity and on the breather itself. Within the meaning of the invention, the term “cover” means both covering with contact and covering without contact.

The transmission mechanism according to the invention may have one or another of the features described below, in combination with each other or taken independently of each other:
the first gear wheel rotates about the first axis of rotation in a preferred direction, the lubricant receiving and distributing collector facing the first gear wheel so that it receives the lubricant splashed by the teeth. According to one example, the preferred direction of rotation of the first gear wheel is that which allows the motor vehicle to move forwards.
the peripheral wall of the casing comprises a cylindrical surface coaxial with the first axis of rotation that partially surrounds the outer periphery of the first gear wheel.
a closure casing is attached to the main casing so as to form a closed enclosure around the speed reduction device, the lubricant receiving and distributing collector being partially held in position either by the main casing or by the closure casing.
a closure casing is attached to the main casing so as to form a closed enclosure around the speed reduction device, the lubricant receiving and distributing collector being held in position partially by the main casing and partially by the closure casing.
the closure casing comprises, on its inner face, at least one drip situated vertically in line with the lubricant receiving and distributing collector.
the main casing comprises, on its inner face, at least one drip situated vertically in line with the lubricant receiving and distributing collector.

The invention also relates, according to another aspect thereof, to an electric propulsion unit comprising an electric machine and a transmission mechanism having all or some of the aforementioned features, the speed reduction system comprising a second transmission shaft guided to rotate about a second axis of rotation X2 by a second guide bearing, and a third transmission shaft guided to rotate about a third axis of rotation X3 by a third guide bearing, one of the transmission shafts selected from among the first, second and third transmission shafts being constrained to rotate with the rotor shaft of the electric machine.

Preferably, a first guide bearing supports the first transmission shaft relative to the casing, the first guide bearing being inserted into a first cylindrical recess formed in the casing, the second guide bearing being inserted into a second cylindrical recess formed in the casing, the third guide bearing being inserted into a third cylindrical recess formed in the casing, the lubricant receiving and distributing collector comprising lubricant outlet pipes emerging towards the cylindrical recess of at least two guide bearings selected from among the first, second and third guide bearings.

Further features and advantages of the invention are revealed by the following description of non-limiting exemplary embodiments of the various aspects of the invention.

### BRIEF DESCRIPTION OF THE FIGURES

Further features and advantages of the invention will become apparent from reading the following description, with reference to the appended figures, in which:

FIG. 1 is a partial front view of a transmission mechanism according to a first embodiment, shown without the closure casing.

FIG. 2 is a cross-sectional view of the transmission mechanism in FIG. 1.

FIG. 3 is a cross-sectional view of a transmission mechanism according to a second embodiment.

FIG. 4 is a partial cross-sectional view of a transmission mechanism according to a third embodiment.

FIG. 5 is a partial cross-sectional view of a transmission mechanism according to a fourth embodiment.

### DETAILED DESCRIPTION OF AN EMBODIMENT

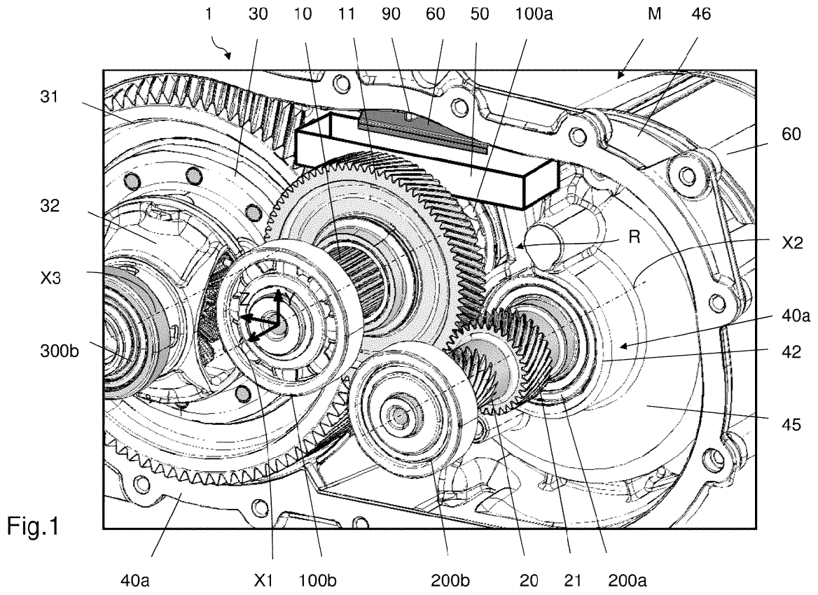

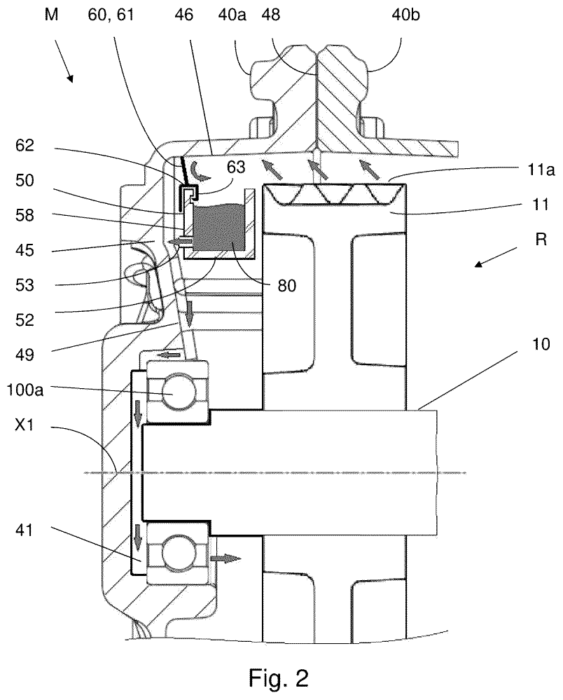

FIGS. 1 and 2 show a transmission mechanism M with internal lubrication according to a first embodiment of the invention. This transmission mechanism M is incorporated within an electric propulsion unit 1 of a vehicle, in particular of an electric motor vehicle, or a secondary powertrain. For example, this may be a secondary electric powertrain of a hybrid vehicle, particularly intended for the rear axle of the vehicle.

In the description and the claims, the terms “outer” and “inner” and the orientations “axial” and “radial” will be used to denote elements of the transmission system according to the definitions given in the description. By convention, the “axial” orientation refers to the reference axes X, Y or Z or to directions parallel to these axes, and the “radial” orientation is directed orthogonally to the reference axes X, Y and Z. A “radially inner” element is situated closer to the reference axis than a “radially outer” element.

The terms “upper”, “lower”, “high”, “low” and “bottom” should be considered when looking at the transmission mechanism M in a position/inclination similar to its own when it is mounted on a vehicle parked horizontally.

The electric propulsion unit 1 comprises an electric machine 60 and the transmission mechanism M, which transmits the torque from the electric machine to the wheels of the electric or hybrid vehicle.

The electric machine 60 may be, for example, an induction electric motor, comprising a rotor and a stator, supplied electrically with a three-phase alternating current by batteries via a current converter (not shown in FIG. 1). The electric machine may be of another type, for example an axial-flux electric machine.

The electric machine 60 is held on a casing 40a, 40b. The casing is generally made up of a main casing 40a supporting the electric machine and a closure casing 40b bearing on the main casing 40a, at a joint line 48, so as to seal closed a cavity delimited by the main casing 40a and the closure casing 40b. The electric machine rotates an input shaft of the transmission mechanism M that enters the main casing 40a.

The transmission mechanism M comprises a speed reduction device R comprising a first transmission shaft 10 that extends along a first axis of rotation X1 and coaxially bears a first gear wheel 11. A first guide bearing 100a supports the first transmission shaft 10 relative to the main casing 40a, the first guide bearing 100a being inserted into a first cylindrical recess 41 formed in the main casing 40a. Another first guide bearing 100b supports the first transmission shaft 10 relative to the closure casing 40b.

The aforementioned first transmission shaft 10 corresponds to the intermediate shaft of the speed reduction device R, which will be described below in the various embodiments.

The speed reduction device R comprises a second transmission shaft 20 corresponding to the input shaft of the transmission mechanism M intended to be driven by the electric machine. This input shaft of the transmission mechanism M is constrained to rotate with the drive shaft of the electric machine. This second transmission shaft 20 is guided to rotate about a second axis of rotation X2 by a second guide bearing 200a. The second guide bearing 200a supports the second transmission shaft 20 relative to the main casing 40a, the second guide bearing 200a being inserted into a second cylindrical recess 42 formed in the main casing 40a. Another second guide bearing 200b supports the second transmission shaft 20 relative to the closure casing 40b.

The speed reduction device R also comprises a third transmission shaft 30 guided to rotate about a third axis of rotation X3 by a third guide bearing 300a, 300b. The third transmission shaft 30, otherwise known as the output shaft of the transmission mechanism M, comprises a torque output gear wheel 31. The third transmission shaft 30 further comprises a connection fixed in rotation with a planet carrier of a differential 32, or constitutes the planet carrier of the differential 32. The differential 32 may be an open or a limited-slip differential, depending on the properties sought.

The first transmission shaft 10 supports the first gear wheel 11 and an intermediate pinion 12. The first gear wheel 11 forms a first reduction stage with the first pinion 21 of the second transmission shaft 20, and the intermediate pinion 12 forms a second reduction stage with the torque output gear wheel 31 of the third transmission shaft 30.

The first, second and third axes of rotation X1, X2, X3 are parallel to each other.

The hollow main casing 40a comprises a base 45 and a peripheral wall 46 integrally formed with the base, the peripheral wall partially surrounding the speed reduction device R. The peripheral wall 46 partially surrounds the first gear wheel 11. In this example, the speed reducer comprises a single speed ratio.

FIG. 1 is a simplified front view of the transmission mechanism M according to the first embodiment of the invention shown without its closure cover so that the interior of the speed reduction device is visible. FIG. 2 shows a partial cross-section of the same transmission mechanism M.

In FIG. 1, the transmission mechanism M is shown in a position corresponding to its position when it is mounted in a vehicle parked on a horizontal plane. It comprises a relatively low part and a relatively high part.

In order to improve the lubrication within the transmission mechanism M, it comprises in particular a lubrication device comprising:
a lubricant receiving and distributing collector 50 comprising at least a bottom 52 and an outer perimeter 58, the lubricant receiving and distributing collector 50 being positioned in the main casing 40a between the peripheral wall 46 and the first axis of rotation X1;
an additional collecting device 60 connected to the outer perimeter 58, the additional collecting device 60 bearing on the peripheral wall 46 of the casing; and
the first gear wheel 11 able to rotate about the first axis of rotation X1, which splashes lubricant from the outer teeth towards the collector.

The lubricant receiving and distributing collector 50 is positioned axially, along the first axis of rotation X1, between the base 45 of the main casing 40a and the first gear wheel 11, the first gear wheel 11 rotating about the first axis of rotation X1 in a preferred direction, the lubricant receiving and distributing collector 50 facing the first gear wheel 11 so that it receives the lubricant splashed by the teeth.

The bottom 52 and the outer perimeter 58 form a collecting reservoir positioned next to the first gear wheel 11.

The additional collecting device 60 comprises a collecting wall 61 that forms the join between the lubricant receiving and distributing collector 50 and the main casing 40a. The end of the collecting wall 61 in contact with the casing comprises a geometric shape that follows the interior shape of the casing, so that it forms a partial seal behind the additional collecting device 60.

In this example, the collector 50 is partially held in position by the main casing 40a, by means of fastening lugs, not shown.

FIG. 2 illustrates the lubrication of this transmission mechanism M, which is partially achieved by the splashing of lubricant (represented by the black arrows), for example oil 80, conveyed by the first gear wheel 11. The oil coming from the bottom of the speed reduction device R is raised upwards by means of the rotation of the first gear wheel 11, and is then splashed towards the peripheral wall 46 of the casing towards the collector 50. Given that the outer periphery 11a of the first gear wheel 11 extends radially beyond the outer perimeter 58 of the lubricant receiving and distributing collector 50, the lubricant may easily fall into the collector.

The first gear wheel 11 rotates about the first axis of rotation X1 in a preferred direction. In this example, the preferred direction of rotation of the first gear wheel is that which allows the motor vehicle to move forwards. The lubricant receiving and distributing collector 50 facing the first gear wheel 11 receives only one portion of the lubricant splashed by the teeth. Another portion of the lubricant is splashed onto the peripheral wall 46 and onto the collecting wall 61 of the additional collecting device 60.

The lubricant 80 trickles along the collecting wall 61 and falls by gravity into the collector 50.

As illustrated in FIG. 2, the lubricant is then distributed towards various regions of the transmission mechanism M. The collector 50 comprises a plurality of holes or pipes 53 that make it possible to allow streams of lubricating oil to flow on various regions of the speed reduction device R.

The oil 80 collected by the lubricant receiving and distributing collector 50 is then partially directed into a channel 49 formed in the main casing 40a in order to be conveyed into the guide bearing 100a, as illustrated by arrows in FIG. 2. The channel 49 emerges into the upper part of the first cylindrical recess 41.

The flow of lubricating oil is therefore conveyed towards the guide bearing 100a to a space available between the bottom of the first cylindrical recess 41 and the rear face of the guide bearing 100a. By gravity, the lubricating fluid descends along the channel 49, then enters the cavity formed by the first cylindrical recess 41 of the main casing 40a before leaving through the bottom portion of the first guide bearing 100a.

As illustrated in FIG. 2, the additional collecting device 60 is attached to the outer perimeter 58 of the lubricant receiving and distributing collector 50. The additional collecting device 60 is made from injection-moulded plastic. The additional collecting device is an attached part comprising the collecting wall 61 and a reinforcing wall 62 positioned on one of the edges of the collecting wall. For greater stability, the reinforcing wall 62 comprises a bearing surface bearing on the outer perimeter 58 of the lubricant receiving and distributing collector.

The reinforcing wall 62 comprises snap-fitting tabs 63 that extend towards the lubricant receiving and distributing collector 50, the additional collecting device 60 being snap-fitted onto the outer perimeter 58.

Stiffening ribs are provided between the reinforcing wall and the collecting wall.

As a variant, the additional collecting device 60 may be made from stamped metal.

The main casing 40a comprises, on the inner face of the peripheral wall 46, a drip 90 situated vertically in line with the collector 50, the drip 90 taking the form of a material protuberance. The drip 90 makes it possible to recover more lubricant within the collector.

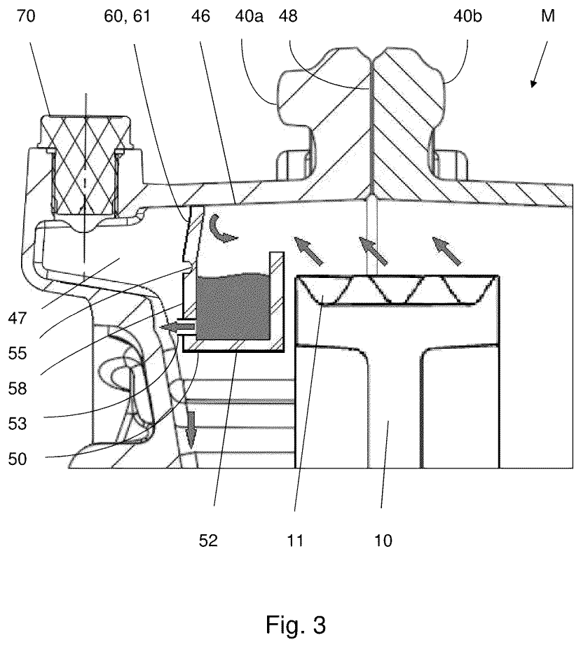

A transmission mechanism M according to a second embodiment of the invention will now be described with reference to FIG. 3, which embodiment differs from the first embodiment in that the additional collecting device 60 is integrally formed with the outer perimeter 58 of the lubricant receiving and distributing collector 50.

The lubricant receiving and distributing collector 50 comprises a flexible region 55 forming the connection between the outer perimeter 58 and the collecting wall 61. In order to absorb the dimensional tolerances and ensure contact with the peripheral wall 46, the collecting wall 61 is elastically hinged in the flexible region 55. The flexible region 55 is produced by a localized narrowing of material.

The end of the collecting wall 61 in contact with the casing comprises a geometric shape that follows the interior shape of the casing, so that it forms a partial seal behind the additional collecting device 60.

As a variant, the flexible region 55 may be produced by localized removal of material, for example a series of oblong holes aligned in one direction.

The additional collecting device 60 may also have another supplementary function, which is that of partially sealing certain inner regions of the transmission mechanism M. In some cases, the transmission mechanism M comprises a breather 70 positioned on an upper portion of the main casing 40a. The breather 70 is configured to prevent the pressure in the space enclosed by the casing 40a, 40b from becoming too high relative to the pressure outside the space.

As illustrated in FIG. 3, the breather 70 is supported by the casing and the inner end of the breather emerges into a cavity 47 formed in the casing. The collecting wall 61 of the additional collecting device 60 at least partially covers the entrance to the cavity 47 and prevents lubricant from splashing directly inside the cavity and on the breather itself.

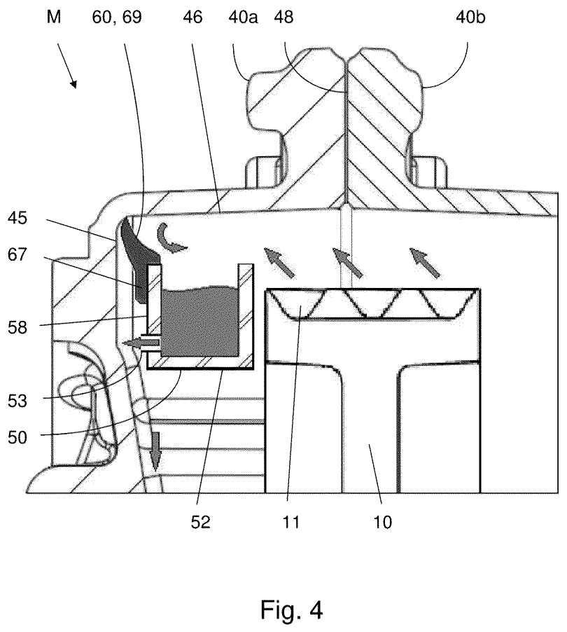

A transmission mechanism M according to a third embodiment of the invention will now be described with reference to FIG. 4, which embodiment differs from the first embodiment in that the additional collecting device 60 is a seal attached to the outer perimeter 58 of the lubricant receiving and distributing collector 50.

As illustrated in FIG. 4, here the seal 60 is overmoulded on the outer perimeter 58 of the lubricant receiving and distributing collector.

The seal 60 comprises a sealing lip 69 that forms the join between the lubricant receiving and distributing collector 50 and the main casing 40a. The sealing lip 69 acts as the collecting wall and deforms elastically in order to absorb the dimensional tolerances and ensure contact with the peripheral wall 46 and the base 45.

For greater stability, the seal 60 comprises a bearing surface 67 bearing on the outer perimeter 58 of the lubricant receiving and distributing collector.

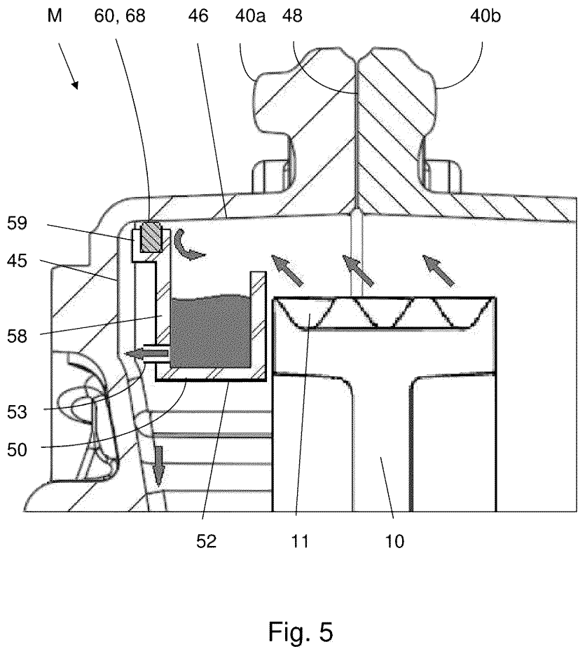

A transmission mechanism M according to a fourth embodiment of the invention will now be described with reference to FIG. 5, which embodiment differs from the first embodiment in that the additional collecting device 60 is a seal attached to the outer perimeter 58 of the lubricant receiving and distributing collector 50. More specifically, the seal 60 is inserted into a groove 59 formed on the outer perimeter 58 of the lubricant receiving and distributing collector 50. The groove 59 partially surrounds the bottom 52.

As illustrated in FIG. 4, here the seal 60 is overmoulded on the outer perimeter 58 of the lubricant receiving and distributing collector.

The seal 60 comprises a resilient body 68 that forms the join between the lubricant receiving and distributing collector 50 and the main casing 40a. The body 68 deforms elastically in order to absorb the dimensional tolerances and ensure contact with the peripheral wall 46.

In the various embodiments described here, the additional collecting device 60 makes it possible to ensure contact between the collecting wall 61 and the peripheral wall 46 despite the possible large variations in their relative positions, linked to the methods for producing the casings and the oil collectors, while retaining simple assembly methods that do not require additional fastening components.

Of course, the invention is described above by way of example. It will be understood that a person skilled in the art is capable of producing various alternative embodiments of the invention without departing from the scope of the invention. For example, the invention, which has been described here in the context of a speed reduction device with a single ratio, may also be applied to a reduction device with two speed ratios or more than two ratios. The invention may also be applied to a coaxial speed reduction device for which the input shaft and the output shaft of the transmission mechanism M are concentric.

1. Transmission mechanism with internal lubrication, comprising:
a speed reduction device comprising at least a first transmission shaft extending along a first axis of rotation and coaxially bearing a first gear wheel,
a hollow casing comprising a base and a peripheral wall integrally formed with the base, the peripheral wall partially surrounding the speed reduction device,
a lubricant receiving and distributing collector positioned in the casing between the peripheral wall and the first axis of rotation,
wherein the lubricant receiving and distributing collector comprises at least a bottom, an outer perimeter and an additional collecting device connected to the outer perimeter, the additional collecting device bearing on the peripheral wall and/or the base of the casing.

2. Transmission mechanism according to claim 1, wherein the lubricant receiving and distributing collector is positioned axially, along the first axis of rotation, between the base of the casing and the first gear wheel, the first gear wheel rotating about the first axis of rotation in a preferred direction, the lubricant receiving and distributing collector facing the first gear wheel so that it receives the lubricant splashed by the teeth.

3. Transmission mechanism according to claim 1, comprising a first guide bearing supporting the first transmission shaft relative to the casing, the first guide bearing being inserted into a first cylindrical recess formed in the casing, the lubricant receiving and distributing collector comprising a lubricant outlet pipe emerging towards the cylindrical recess.

4. Transmission mechanism according to claim 1, comprising a breather supported by the casing, the inner end of the breather emerging into a cavity formed in the casing, the collecting wall of the additional collecting device at least partially covering the entrance to the cavity.

5. Transmission mechanism according to claim 1, wherein the additional collecting device is attached to the outer perimeter or integrally formed with the outer perimeter, the additional collecting device comprising a collecting wall that forms the join between the lubricant receiving and distributing collector and the casing.

6. Transmission mechanism according to claim 5, wherein the end of the collecting wall in contact with the casing comprises a geometric shape that follows the interior shape of the casing, for example a curved shape.

7. Transmission mechanism according to claim 5, wherein the additional collecting device is an attached part comprising the collecting wall and a reinforcing wall positioned on one of the edges of the collecting wall, the reinforcing wall comprising a bearing surface bearing on the outer perimeter of the lubricant receiving and distributing collector.

8. Transmission mechanism according to claim 7, wherein the reinforcing wall comprises snap-fitting tabs that extend towards the lubricant receiving and distributing collector, the additional collecting device being snap-fitted onto the outer perimeter.

9. Transmission mechanism according to claim 5, wherein the additional collecting device is integrally formed with the outer perimeter, the lubricant receiving and distributing collector comprising a flexible region forming the connection between the outer perimeter and the collecting wall, the flexible region being produced by localized narrowing of material or localized removal of material.

10. Transmission mechanism according to claim 1, wherein the additional collecting device is a seal attached to the outer perimeter.

11. Transmission mechanism according to claim 10, wherein the seal comprises a sealing lip that forms the join between the lubricant receiving and distributing collector and the casing, the sealing lip acting as the collecting wall.

12. Transmission mechanism according to claim 10, wherein the seal is overmoulded on the outer perimeter of the lubricant receiving and distributing collector.

13. Transmission mechanism according to claim 10, wherein the seal is inserted into a groove formed on the outer perimeter of the lubricant receiving and distributing collector.

14. Transmission mechanism according to claim 1, wherein the casing comprises, on the inner face of the peripheral wall, at least one drip situated vertically in line with the lubricant receiving and distributing collector, the drip taking the form of a protuberance of material and the additional collecting device bearing on the drip.

15. Electric propulsion unit comprising an electric machine and a transmission mechanism according to claim 1, the speed reduction system comprising a second transmission shaft guided to rotate about a second axis of rotation by a second guide bearing, and a third transmission shaft guided to rotate about a third axis of rotation by a third guide bearing, one of the transmission shafts selected from among the first, second and third transmission shafts being constrained to rotate with the drive shaft of the electric machine.

16. Transmission mechanism according to claim 2, comprising a first guide bearing supporting the first transmission shaft relative to the casing, the first guide bearing being inserted into a first cylindrical recess formed in the casing, the lubricant receiving and distributing collector comprising a lubricant outlet pipe emerging towards the cylindrical recess.

17. Transmission mechanism according to claim 2, comprising a breather supported by the casing, the inner end of the breather emerging into a cavity formed in the casing, the collecting wall of the additional collecting device at least partially covering the entrance to the cavity.

18. Transmission mechanism according to claim 2, wherein the additional collecting device is attached to the outer perimeter or integrally formed with the outer perimeter, the additional collecting device comprising a collecting wall that forms the join between the lubricant receiving and distributing collector and the casing.

19. Transmission mechanism according to claim 6, wherein the additional collecting device is an attached part comprising the collecting wall and a reinforcing wall positioned on one of the edges of the collecting wall, the reinforcing wall comprising a bearing surface bearing on the outer perimeter of the lubricant receiving and distributing collector.

20. Transmission mechanism according to claim 6, wherein the additional collecting device is integrally formed with the outer perimeter, the lubricant receiving and distributing collector comprising a flexible region forming the connection between the outer perimeter and the collecting wall, the flexible region being produced by localized narrowing of material or localized removal of material.
